(19) United States
(12) Patent Application Publication
(10) Pub. No.: US 2008/0020821 A1
(43) Pub. Date: Jan. 24, 2008

(54) Gaming machine, management server, and game control method

(75) Inventor: Hiro Sakuma, Tokyo (JP)

Correspondence Address: ARENT FOX LLP, 1050 CONNECTICUT AVENUE, N.W., SUITE 400, WASHINGTON, DC, 20036, US

(73) Assignee: Aruze Corp.

(21) Appl. No.: 11/826,817

(22) Filed: Jul. 18, 2007

(30) Foreign Application Priority Data
Jul. 24, 2006 (JP) 2006-200627

(51) Int. Cl. G06F 17/00

(52) U.S. Cl. 463/25; 463/40

(57) ABSTRACT

A gaming machine is provided with an enhanced entertainment feature, incorporating an element similar to the trading of stocks and bonds in a game. The gaming machine is connected via a communication line to a management server that determines a conversion rate based on a conversion history between credit data usable in a game and numerical data convertible with credit data. The gaming machine has a storage unit and a processing unit. The storage unit stores credit data and numerical data. When the conditions for conversion to numerical data are met, the processing unit executes the process of converting credit data to numerical data based on a conversion rate determined by the management server. When the conditions for conversion to credit data are met, the processing unit executes the process of converting numerical data to credit data based on a conversion rate decided by the management server.

This application is based on and claims the benefit of priority from Japanese Patent Application No. 2006-200627, filed on Jul. 24, 2006, the content of which is incorporated herein by reference.

### BACKGROUND OF THE INVENTION

1. Field of the Invention

The present invention relates to a gaming machine for playing a game by using a gaming medium, a management server for managing a game in the gaming machine, and a game control method of a gaming system provided with the gaming machine and the management server.

2. Related Art

In the facilities where gaming machines such as slot machines are installed, users (players) can play a game by inserting a gaming medium (a gaming value) such as a coin into the game machines. These gaming machines are configured to pay out prizes depending on a winning condition (a game result) occurring by the progress of the game.

Meanwhile, in stocks and bonds such as stock certificates, values can be decided by a balance between supply and demand, namely the negotiation between seller and buyer. Deciding good timings for buying and selling is a kind of gambling. Recently, there have been games employing the element of the trading of the stocks and bonds. There already exists a point processing system that manages points issued by business establishments or the like, and also enables conversion to value variable financial products (for example, refer to Japanese Unexamined Patent Application Publication No. 2004-152160).

### SUMMARY OF THE INVENTION

According to the invention, a gaming machine is provided which is connected via a communication line to a management server that determines a conversion rate based on a conversion history between credit data usable in a game and numerical data convertible with credit data. The gaming machine includes a storage unit for storing credit data and numerical data, and a processing unit. The processing unit executes processes of: (a) storing, in the storage unit, numerical data converted from the credit data based on a conversion rate determined by the management server; and (b) storing, in the storage unit, credit data converted from the numerical data based on a conversion rate determined by the management server. The processing unit may execute the process of storing, in the storage unit, numerical data converted from the credit data if conditions for conversion to numerical data are met. The processing unit may execute the process of storing, in the storage unit, credit data converted from the numerical data if conditions for conversion to credit data are met.

According to the gaming machine of the present invention, numerical data can be used to change the value thereof apart from credit data having values per unit that remain unchanged. Consequently, even with the gaming machine using credit data having values per unit that remain unchanged, an element similar to the trading of stocks and bonds can be incorporated in a game so as to enhance the entertainment feature of the game in the gaming machine.

According to the present invention, a management server is also provided that is connected via a communication line to a plurality of gaming machines. The management server includes a storage unit and a processing unit. The storage unit stores a conversion history between credit data and numerical data convertible with credit data. The processing unit executes processes of: (a) receiving conversion results between credit data and numerical data in the plurality of gaming machines, and (b) calculating a conversion rate based on the data of the conversion results and the data of the conversion history; and (c) sending the conversion rate to the plurality of gaming machines.

According to the management server of the invention, numerical data can be used to change the value thereof apart from credit data having values per unit that remain unchanged. Consequently, even with the gaming machines using credit data having values per unit that remain unchanged, an element similar to the trading of stocks and bonds can be incorporated into a game so as to enhance the entertainment factor of the game in the gaming machines.

According to the present invention, a game control method of controlling a gaming system is provided that includes a management server storing a conversion history, and a plurality of gaming machines which are connected via a communication line to the management server, and store credit data and numerical data. The game control method includes steps of: (a) having the management server calculate a conversion rate between credit data and numerical data; (b) having the management server send the conversion rate to the plurality of gaming machines; (c) having the gaming machines receive the conversion rate; (d) having the gaming machines convert credit data to numerical data based on the conversion rate; (e) having the gaming machines store conversion results between the credit data and the numerical data; and (f) having the gaming machines send the conversion results to the management server.

According to the game control method of the invention, numerical data can be used to change the value thereof apart from credit data having values per unit that remain unchanged. Consequently, even with the gaming machines using credit data having values per unit that remain unchanged, an element similar to the trading of stocks and bonds can be incorporated in a game so as to enhance the entertainment factor of the game in the gaming machines.

In one embodiment of the gaming machine or the game control method of the present invention, the gaming machine may include a display unit that displays a plurality of symbols. The processing unit provided in the abovementioned gaming machine executes the process of allowing conversion between credit data and numerical data when rearrangement of the plurality of symbols results in a predetermined combination.

According to the gaming machine or the game control method of the present invention, the conversion of credit data to numerical data is allowed in the condition where a predetermined combination of symbols occurs to increase the credit. Therefore, the player can be given an incentive to convert credit data to numerical data. Furthermore, the number of times to perform the conversion process can be restricted, thereby preventing overloading of the gaming machines and the management server.

In another embodiment of the gaming machine or the game control method of the invention, the gaming machine may include a display unit that displays a plurality of symbols, and a stop switch that outputs a stop instruction signal to stop and display the plurality of symbols for variable display, in accordance with a manipulation via a player. Upon detecting the stop instruction signal from the stop switch, the abovementioned operating unit provided in the abovementioned gaming machine performs the process of stopping and displaying the plurality of symbols for variable display. When the plurality of symbols stopped and displayed corresponds to a predetermined combination, the abovementioned operating unit provided in the abovementioned gaming machine performs the process of allowing the conversion between credit data and numerical data.

According to the gaming machine or the game control method of the present invention, the conversion is possible only when the stopped and displayed symbols correspond to a predetermined combination. This provides a game feature where the conversion is not always possible at the desired timing. In the period of time that a player desires the conversion in particular, there may be a high possibility that the player will perform many games. This enables the player to enjoy both the game and the conversion game. Furthermore, performing the stop operation can give the player the feeling of satisfaction that the conversion could be made at the desired timing by the strategy of the player.

In yet another embodiment of the gaming machine or the game control method of the present invention, the gaming machine may include a conversion rate display unit for displaying a conversion rate. The abovementioned processing unit provided in the abovementioned gaming machine executes the process of displaying a conversion rate on the conversion rate display unit.

With the gaming machine and the game control method according to the present invention, the player can view a conversion rate. This enables the player to consider the conversion timing while viewing the conversion rate, which that varies from time to time, and decide whether to make the conversion in consideration of the progress up to then.

It is therefore an advantage of the present invention to provide a gaming machine capable of incorporating a new entertainment feature, as well as a management server and a game control method.

Additional features and advantages of the present invention are described in, and are apparent from, the following detailed description of the invention and the drawings.

### BRIEF DESCRIPTION OF THE DRAWINGS

FIG. 1 is a schematic diagram showing the overall configuration of a gaming system according to a preferred embodiment of the invention;

FIG. 2 is a perspective view schematically showing the gaming machine of the preferred embodiment;

FIG. 3 is a schematic diagram showing the columns of symbols displayed on the outer peripheral surfaces of reels;

FIG. 4 is a block diagram showing the internal configuration of the gaming machine shown in FIG. 2;

FIG. 5 is a block diagram showing the internal configuration of a controller according to the preferred embodiment;

FIG. 6 is a diagram illustrating a conversion rate;

FIG. 7 is a flow chart showing a subroutine of a game execution process;

FIG. 8 is a diagram showing an example of images displayed on a lower image display panel;

FIG. 9 is a diagram showing an example of images displayed on a lower image display panel;

FIG. 10 is a flow chart showing a subroutine of a lottery process;

FIG. 11 is a table illustrating the relationship between a plurality of types of winning combinations, and the possibilities of forming these winning combinations and the payout number;

FIG. 12 is a flow chart showing a subroutine of a bonus game process; and

FIG. 13 is a flow chart showing a conversion rate related process executed between gaming machines and a management server.

### DETAILED DESCRIPTION OF THE INVENTION

### Definition of Terms

The term “credit data” indicates data usable in a game. In the gaming machine, the insertion of a coin, a bill (paper currency) or the like can be converted to credit data of a predetermined amount. For example, the insertion of a coin can be converted to the data of a credit count of 1, and the insertion of two coins can be converted to the data of a credit count of 2. When a bill is inserted, the number of coins corresponding to the money value of the bill is calculated, and then converted to data indicating that number. The credit data thus converted enables a player to perform a game. Specifically, in a game of the gaming machine such as a slot machine, the player can play a predetermined game by performing a predetermined operation and using (consuming) a predetermined amount of credits.

The term “numerical data” indicates data convertible with credit data and vice versa, and numerical data are different from credit data.

The term “conversion rate” indicates a rate at which credit data and numerical data are mutually converted.

The term “conversion rate varies” indicates that the conversion rate between credit data and numerical data varies. For example, a credit of “10” can be converted to a numerical value of “8” at the conversion rate at a certain point in time, and the credit of “10” can be converted to a numerical value of “7” at the conversion rate at another point.

The term “conversion result data” indicates data representing the result of the executed conversion between credit data and numerical data.

The term “conversion history data” indicates data representing the history of conversions between credit data and numerical data which have been executed in all of a plurality of gaming machines connected via a communication line.

A method for converting between “credit data” and “numerical data” based on “a variable conversion rate” is described below.

First, a gaming system according to the invention is described.

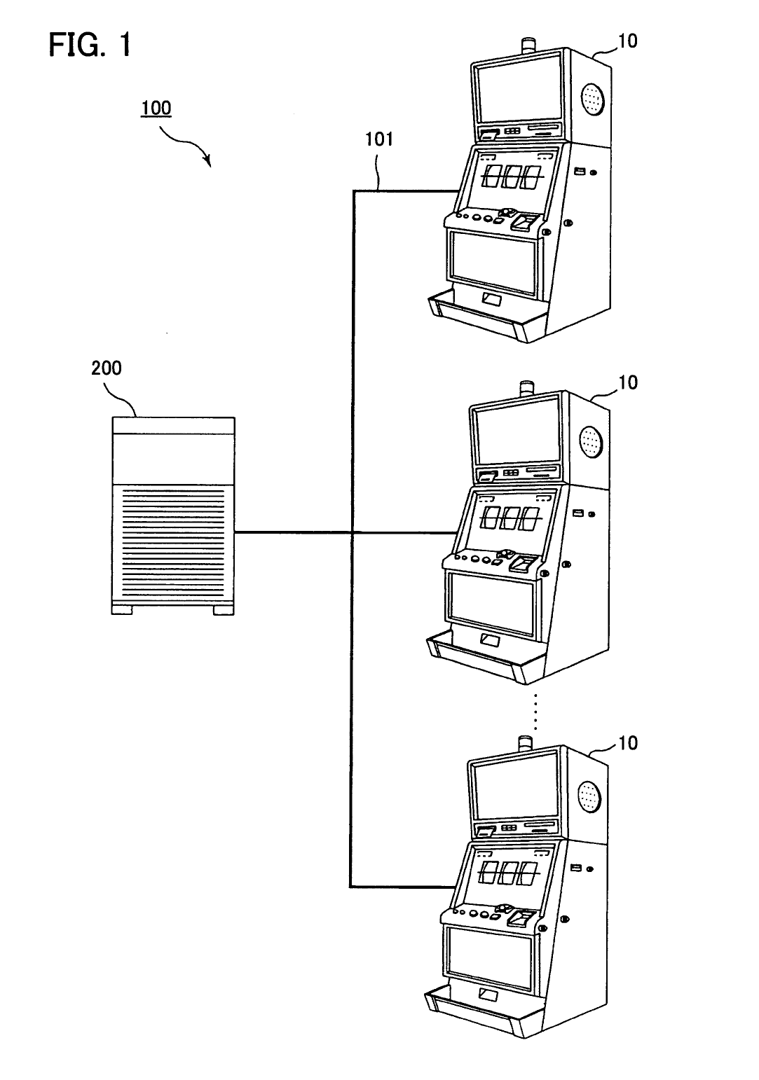

FIG. 1 is a perspective view showing the overall configuration of a gaming machine according to a preferred embodiment of the invention. A gaming system 100 has a plurality of gaming machines 10, and a management server 200 connected via a predetermined communication line 101 to these gaming machines 10. The gaming system 100 may be configured in an amusement facility permitting different games, such as a bar or a casino. Alternatively, it may be configured over a plurality of amusement facilities. In the case of configuring in an amusement facility, the gaming system 100 may be configured per floor or section in the amusement facility. No special limitations are imposed on the communication line 101. It may be a wire or wireless, and a dedicated line or a conversion line may be employed.

The gaming machines 10 store a coin or a bill inserted as credit data. The credit data can be used to perform a game. The gaming machine 10 can execute conversion between credit data and numerical data. The conversion between credit data and numerical data may be executable at anytime, or allowable only when a predetermined condition is met. Examples of the predetermined condition are when the rearranged symbols in a game correspond to a predetermined combination, and when it is a predetermined time. Alternatively, the gaming machines 10 may include a stop switch. Here, the abovementioned predetermined condition may be a case when a plurality of symbols stopped and displayed by the operation of the stop switch corresponds to a predetermined combination. In the following, the numerical data in the present invention are referred to as stock data, and the number indicated by the stock data is the number of stocks.

The gaming machines 10 perform conversion between credit data and stock data, and send conversion result data indicating the conversion results to the management server 200. The conversion result data may be, for example, data indicating the credit count to be incremented or decremented by the conversion, or data containing the number of stocks to be incremented or decremented by the conversion, or data containing both the credit count and the number of stocks to be incremented or decremented. That is, no special limitations are imposed on the conversion result data as long as they contain the contents of the conversion between credit data and stock data performed by the gaming machines 10.

The management server 200 stores conversion history data. Based on the conversion result data received from the respective gaming machines 10 and the conversion history data stored in the management server 200, the management server 200 calculates a conversion rate. Although no special limitations are imposed on the timing to calculate the conversion rate, it may be calculated every time the management server 200 receives conversion result data, or at predetermined time intervals. For example, the conversion history data may be data indicating the entire balance when credit data and stock data are converted in all of the gaming machines 10, or data indicating the whole of the conversion result data received from the respective gaming machines.

Although no special limitations are imposed on the method of calculating a conversion rate, it is preferable that when a large amount of credit data are converted to stock data, the method facilitates the conversion of more stock data to credit data. For example, the calculation may be made with the following formula:

(Conversion history data(Entire balance)+Conversion result data(Conversion result))/(Constant).

The management server 200 sends conversion rate data indicating the calculated conversion rate to the gaming machines 10. Although no special limitations are imposed on the timing to send the conversion rate data to the gaming machines 10, it may be, for example, upon the receipt of conversion result data, upon the completion of conversion rate data, or when the gaming machines 10 cause a request to send the conversion rate data.

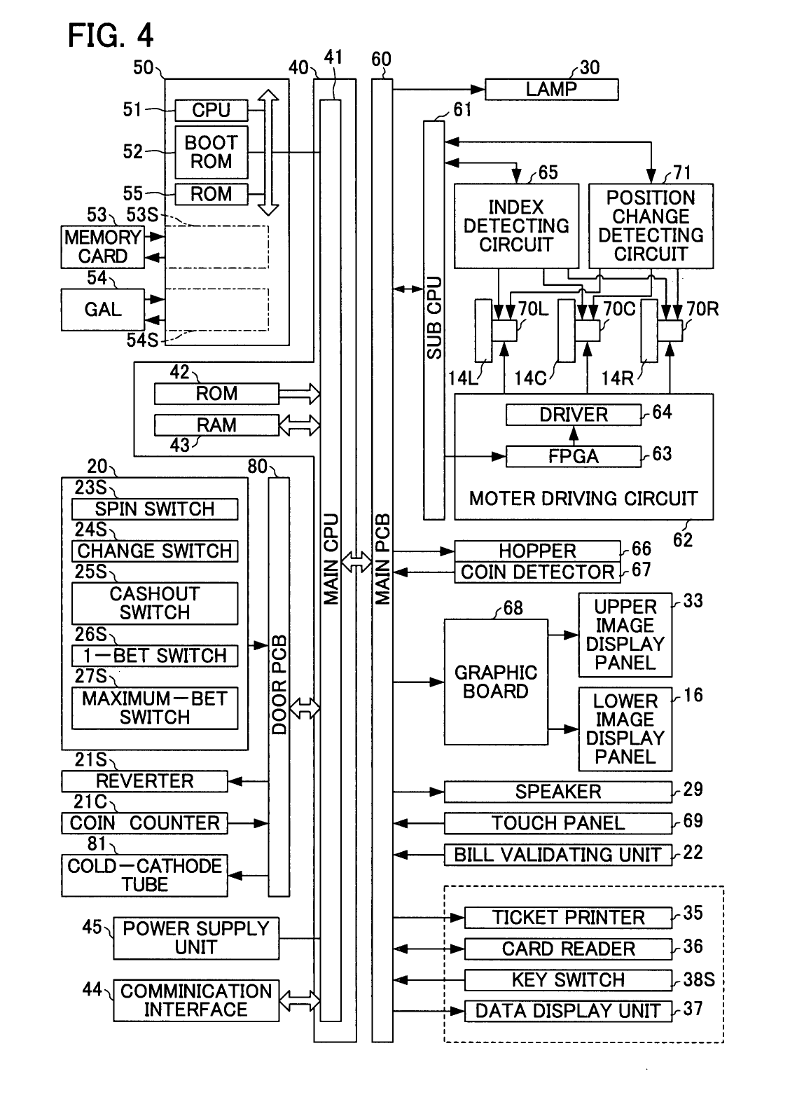

The gaming machines 10 receive the conversion rate data and store the data in RAM 43 (refer to FIG. 4). In the present invention, the conversion rate is preferably displayed. Although no special limitations are imposed on the method of displaying the conversion rate, for example, the current conversion rate may be displayed, or a graph of the progress of conversion rates from the past to the present may be displayed. On the receipt of the input of conversion between credit data and numerical data, the gaming machines 10 perform the conversion between credit data and stock data based on the conversion rate data.

Thus, the present invention enables an element similar to the trading of stocks and bonds to be incorporated in the game in the gaming machines. This leads to a gaming machine that provides a game with an enhanced entertainment feature, as well as a management server and a game control method.

For a better understanding of the present invention, the following description consists mainly of the characteristic features of the invention.

The invention is not limited to the following preferred embodiment, and is applicable to other embodiments in a wide variety of uses. The terms and the uses thereof are for accurately explaining the invention, not for limiting the interpretation of the invention. It seems to be easy for those skilled in the art to think of other configurations, systems, and methods contained in the concept of the invention, from the concept of the invention described in the present specification. Consequently, the description of the appended claims should be regarded as containing an equal configuration without departing from the scope of the technical idea of the invention. The appended abstract is for enabling engineers or the like in the art, who are not familiar with the patent office, general public institution, patents, law terms, or technical terms, to easily understand the technical contents and the substance of the present application by a simple investigation. Hence, the abstract is not intended for limiting the scope of the invention that should be evaluated by the appended claims. It is desirable to sufficiently review literatures and documents that are already disclosed, in order to understand the object of the invention and the novel effect of the invention.

The following detailed description contains processes to be executed on a computer or a computer network. The following description and expression are to enable those skilled in the art to understand more effectively. In the present specification, the processes for deriving a result should be understood as a process in which no self-conflict exists. In the respective steps, electrical or magnetic signals are sent and received, or written. Although in the processes of the respective steps, these signals are expressed in bit, value, symbol, character, term, or figure, these are used only for convenience in explaining. Although the processes in the steps may be described in an expression common to the action of human beings in some cases, the processes described in the present specification are in principle executed by various units. Other configurations required for executing the steps will be obvious from the following description.

A preferred embodiment of the invention is described with reference to the accompanying drawings.

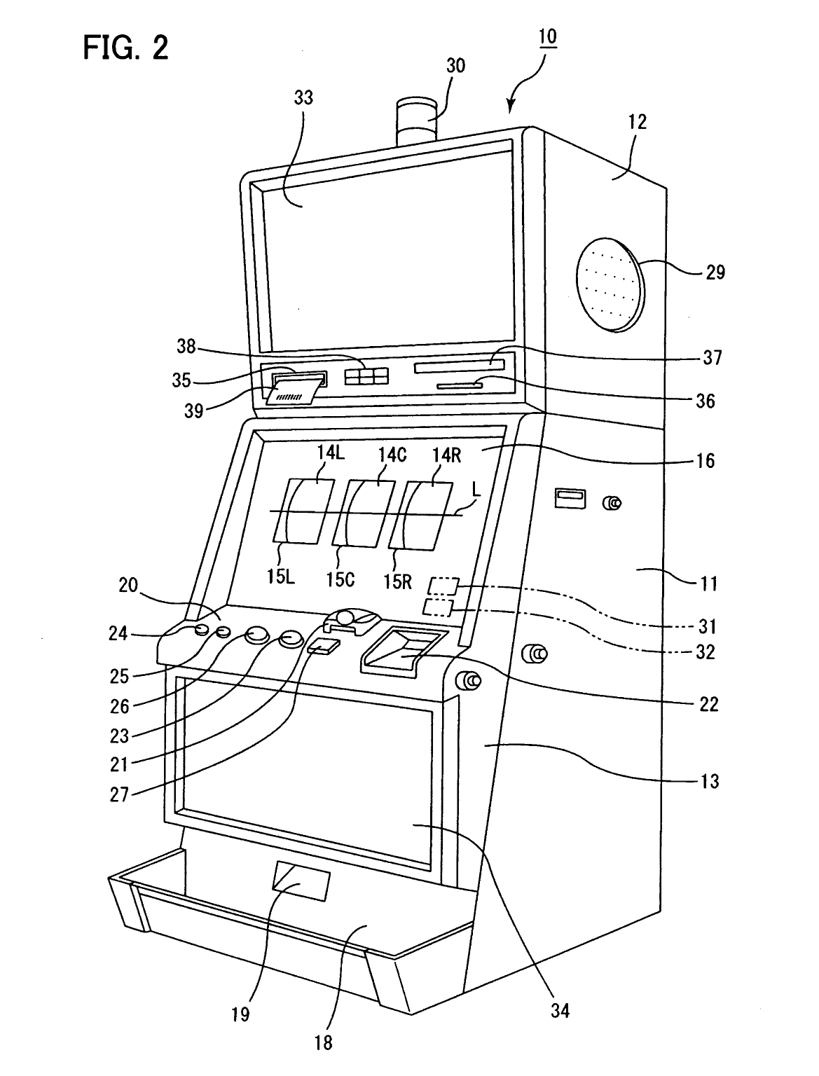

FIG. 2 is a perspective view schematically showing a gaming machine according to the preferred embodiment of the invention. In the present embodiment, the gaming machines 10 are slot machines. However, it is to be understood that the gaming machines of the present invention are not limited to slot machines, and they may be so-called single gaming machines such as video slot machines, video card games, or so-called mass gaming machines (multi-terminal gaming machines) for performing a game that calls for a predetermined period of time before a result is displayed, such as a horse racing game, a bingo game, or a lottery.

The gaming machines 10 employ as a gaming medium, coins, bills, or electronic financial information corresponding to these. However, the present invention imposes no special limitations upon the gaming medium, and may employ medals, tokens, electronic money, or tickets. No special limitations are imposed on the abovementioned tickets. For example, bar coded tickets to be described later may be used.

The gaming machines 10 have a cabinet 11, a top box 12 disposed on the cabinet 11, and a main door 13 disposed on a front face of the cabinet 11. Three reels 14 (14L, 14C, and 14R) are rotatably disposed on the inside of the cabinet 11. The outer peripheral surfaces of the respective reels are provided with the columns of symbols made up of 22 patterns (hereinafter referred to as “symbols” in some cases).

A lower image display panel 16 as a display unit is disposed in front of the respective reels 14 in the main door 13. The lower image display panel 16 has a transparent liquid crystal panel, on which various information of a game and produced images are displayed when the gaming machine is in use.

The lower image display panel 16 has a credit count display part 31 and a payout number display part 32. The credit count display part 31 displays the image of the number of coins credited. The payout display part 32 displays an image of the number of coins to be paid out when a symbol combination stopped and displayed on a winning line L corresponds to a predetermined combination.

The lower image display panel 16 is provided with three display windows 15 (15L, 15C, and 15R), the backface of which is visible. Any three of the symbols drawn on the outer peripheral surfaces of the reels 14 can be displayed through the display windows 15, respectively. The lower image display panel 16 is provided with the winning line L horizontally crossing over the three display windows 15. The winning line L is for defining symbol combinations. When the symbol combination stopped and displayed on the winning line L corresponds to a predetermined combination, the number of coins based on the combination and the number of coins inserted (the number of bets) can be paid out.

As an alternative, for example, a plurality of winning lines L horizontally or obliquely crossing over the three display windows 15 may be formed, and the number of the winning lines L corresponding to the number of coins inserted may be activated. When the symbol combination stopped and displayed on the activated winning lines L corresponds to a predetermined combination, the number of coins based on the combination may be paid out.

The front face of the lower image display panel 16 has a touch panel 69 (not shown). The player can operate the touch panel 69 to input various kinds of instructions.

Below the lower image display panel 16, there is a control panel 20 including a plurality of buttons 23 to 27, through which the player inputs instructions to advance the game, a coin slot 21 that accepts coins into the cabinet 11, and a bill validating unit 22.

The control panel 20 is provided with a spin button 23, a change button 24, a cash out button 25, a one bet button 26, and a maximum bet button 27. The spin button 23 is for inputting an instruction to start the rotation of the reels 14. The change button 24 is for calling a staff member of a gaming facility to change money. The cash out button 25 is for inputting an instruction to pay out the credited coins to a coin tray 18.

The one bet button 26 is for inputting an instruction to bet one coin of the credited coins on the game. The maximum bet button 27 is for inputting an instruction to bet the maximum number of coins (50 coins in the present embodiment) that can be bet per game.

In the present invention, the insertion of a gaming medium indicates that the gaming medium is bet on a game. For example, where a coin inserted into the coin slot 21 is directly bet on the game, the insertion of the coin into the coin slot 21 corresponds to the insertion of the gaming medium. However, as in the present embodiment, when a coin inserted into the coin slot 21 is temporarily credited, and the credited coin can be bet on a game by the operation of the one bet button 26 or the maximum bet button 27, betting the credit coin on the game corresponds to the insertion of the gaming medium.

The bill validating unit 22 is for determining whether the bill is valid or not, and for accepting the valid bill into the cabinet 11. The bill validating unit 22 may be configured so that it can read a bar coded ticket 39 described later. A berry glass 34, on which the characters of the gaming machine 10 and the like are displayed, is disposed in a lower front of the main door 13, namely below the control panel 20.

An upper image display panel 33 is disposed in the front face of the top box 12. The upper image display panel 33 has a liquid crystal panel, which displays, for example, the images for the introduction of the game content and an explanation of the rules of the game.

The top box 12 has a speaker 29. A ticket printer 35, a card reader 36, a data display unit 37, and a key pad 38 are disposed below the upper image display panel 33. The ticket printer 35 prints on a ticket a bar code in which the data related to the credit count, the time, and the identification number of the gaming machine 10 are coded, and outputs this as a bar coded ticket 39. The player can manipulate other gaming machines to read the bar coded ticket 39 in order to play a game with this gaming machine, and convert the bar coded ticket 39 to a bill or the like at a predetermined place in the gaming facility (for example, a cashier within a casino).

The card reader 36 reads data from a smart card and writes data in the smart card. The smart card is a card possessed by a player that stores, for example, data for identifying the player, and data related to the history of the games performed by the player. Alternatively, the smart card may store data corresponding to coins, bills, or credit. Instead of the smart card, a magnetic stripe card may be employed. The data display unit 37 is formed of a fluorescent display or the like, and displays data read by the card reader 36, and data inputted through the key pad 38 by the player. The key pad 38 is for inputting instructions and data related to the issue of a ticket, or the like.

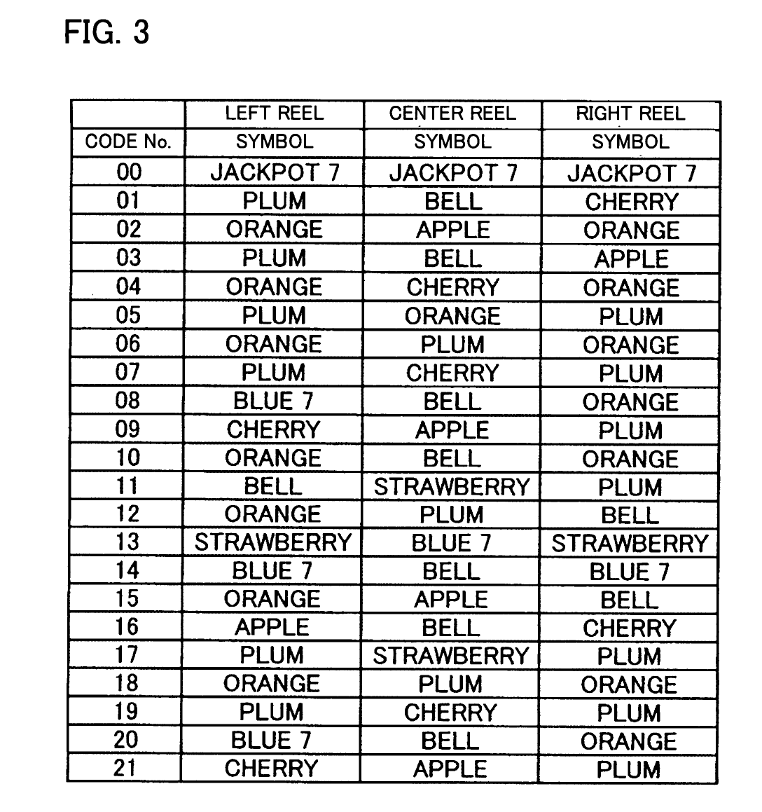

FIG. 3 is a schematic diagram showing the columns of symbols drawn on the outer peripheral surfaces of the respective reels. The outer peripheral surfaces of the left reel 14L, the middle reel 14C, and the right reel 14R are provided with 22 symbols, respectively. The respective columns of the symbols displayed on the reels 14 are different from each other. The respective columns of the symbols are configured by combining “JACKPOT 7,” “BLUE 7,” “BELL,” “CHERRY,” “STRAWBERRY,” “PLUM,” “ORANGE,” “APPLE.”

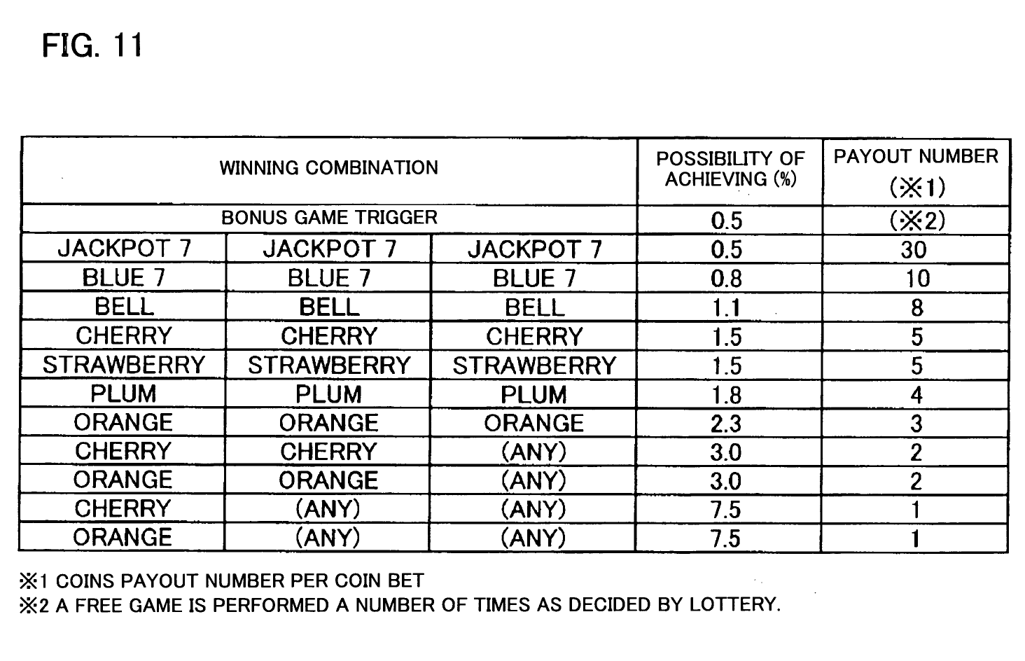

When any three symbols of “JACKPOT 7,” “BLUE 7,” “BELL,” “CHERRY,” “STRAWBERRY,” “PLUM,” and “ORANGE” are stopped and displayed on the winning line L, a predetermined credit count can be added to the credits possessed by the player (refer to FIG. 11). When one symbol or two symbols of “CHERRY” and “ORANGE” are stopped and displayed, depending on the number of the symbols, a predetermined credit count can be added to the credits possessed by the player (refer to FIG. 11).

The symbol “APPLE” is a bonus game trigger (the symbol for moving on to the bonus game). When three “APPLEs” are stopped and displayed on the winning line L, the player can move on to the bonus game. In the present embodiment, the bonus game is a free game (a game that can be played a predetermined number of times without betting any coins).

When the spin button 23 is pressed after pressing the one bet button 26 or the maximum bet button 27, the columns of the symbols depicted on the reels 14 are displayed by scrolling from top to down in the display window 15 as the reels 14 are rotated. After a predetermined period of time, the columns of the symbols are stopped, and displayed in the display window 15 as the rotation of the reels 14 are stopped. Various types of winning combinations are predetermined based on the symbol combinations (refer to FIG. 11). When a symbol combination corresponding to a winning combination comes to stop on the winning line L, the number of coins paid out corresponding to the winning combination can be added to the credits of the player. Furthermore, when the bonus game is triggered, the bonus game is executed.

FIG. 4 is a block diagram showing the internal configuration of the gaming machine shown in FIG. 2. A gaming board 50 has a CPU (central processing unit) 51, ROM 55, boot ROM 52, a card slot 53S corresponding to a memory card 53, and an IC socket 54S corresponding to a GAL (generic array logic) 54, all of which are connected to each other by an internal bus.

The memory card 53 is formed of a nonvolatile memory such as Compact Flash®, and stores a game program. The game program contains a lottery program. The lottery program determines symbols (the code numbers corresponding to the symbols) to be stopped and displayed on the winning line L.

The card slot 53S is configured so that the memory card 53 can be inserted and removed, and connected to a motherboard 40 by an IDE bus. Therefore, the type and the content of a game performed by the gaming machine 10 can be changed by removing the memory card 53 from the card slot 53S, and writing other game program in the memory card 53, and then inserting the memory card 53 in the card slot 53S. The game program contains a program related to the progress of the game, and a program related to the conversion between credit data and stock data. The game program also contains a program related to image data and sound data.

The CPU 51, the ROM 55, and the boot ROM 52, which are connected to each other by the internal bus, are connected to the motherboard 40 by a PCI bus. The PCI bus performs signal transmission between the motherboard 40 and the gaming board 50, and supplies power from the motherboard 40 to the gaming board 50.

The motherboard 40 can be configured by using a general purpose motherboard (a printed wiring board equipped with the basic components of a personal computer) on the market. The motherboard 40 has a main CPU 41, ROM (read only memory) 42, RAM (random access memory) 43, and a communication interface 44. The main CPU 41 is a processing unit in the present invention.

The ROM 42 stores a program such as a BIOS (basic input/output system) and the like, and permanent data. The BIOS is formed of a memory device such as a flash memory, and is executed by the main CPU 41. The execution of the BIOS by the main CPU 41 enables the initialization process of predetermined peripheral equipment, and the capture process of the game program stored in the memory card 53 through the gaming board 50. In the present invention, the ROM 42 may be one having content that is rewritable or not.

The RAM 43 stores data and a program to be used when the main CPU 41 is operated. The RAM 43 can also store a game program.

The RAM 43 as a storage unit is provided with storage areas of conversion rate data, credit data, and stock data. The RAM 43 further stores the data of the credit count and the sum of inserted credits and the sum of payout in a game.

The communication interface 44 enables communication with the management server 200 through the communication line 101. At the completion of a conversion between credit data and stock data, the main CPU 41 sends conversion result data indicating the conversion result to the management server 200.

Based on the conversion result data received from the respective gaming machines 10, the management server 200 calculates a conversion rate, and sends conversion rate data indicating the conversion rate to the respective gaming machines 10 at predetermined time intervals. Upon the receipt of the conversion rate data through the communication interface 44, the main CPU 41 updates the conversion rate.

A main PCB (printed circuit board) 60 and a door PCB 80, to be described later, are connected to the motherboard 40 by a USB, respectively. A power supply unit 45 is connected to the motherboard 40.

The equipment and the unit for generating an input signal to be inputted to the main CPU 41, and the equipment and the unit having operation controlled by a control signal outputted from the main CPU 41, are connected to the main PCB 60 and the door PCB 80. Based on the input signal inputted to the main CPU 41, the main CPU 41 executes the game program stored in the RAM 43 to perform a predetermined operation, and stores the result thereof in the RAM 43, and also sends the control signal to the equipment and the unit, as the control process to these.

A lamp 30, a sub CPU 61, a hopper 66, a coin detector 67, a graphic board 68, a speaker 29, a touch panel 69, the bill validating unit 22, the ticket printer 35, the card reader 36, the key switch 38, and the data display unit 37 are connected to the main PCB 60. The lamp 30 illuminates in a predetermined pattern based on a control signal outputted from the main CPU 41.

The sub CPU 61 controls the rotation and stopping of the reels 14 (14L, 14C, and 14R). A motor driving circuit 62 having an FPGA (field programmable gate array) 63 and a driver 64 is connected to the sub CPU 61. The FPGA 63 is an electronic circuit such as a programmable LSI, and functions as a control circuit of stepping motors 70. The driver 64 functions as an amplification circuit of pulses inputted to the stepping motors 70. The stepping motors 70 (70L, 70C, and 70R) for rotating the respective corresponding reels 14 thereof are connected to the motor driving circuit 62. The stepping motors 70 are stepping motors of single- or two-phase power type.

An index detecting circuit 65 and a position change detecting circuit 71 are connected to the sub CPU 61. The index detecting circuit 65 detects the positions of the rotating reels 14 (indexes to be described later), and can detect the step out of the reels 14.

The position change detecting circuit 71 detects changes in the stop positions of the reels 14 at the termination of the rotation of the reels 14. The position change detecting circuit 71 detects changes in the stop positions of the reels 14, for example, when a player forceably changes the stop positions to make a winning combination of symbols though they are actually not. The position change detecting circuit 71 is configured to detect the changes in the reels 14 by detecting, for example, fins (not shown) fixed at predetermined intervals on internal portions of the reels 14.

The hopper 66 is disposed in the cabinet 11. Based on a control signal outputted from the main CPU 41, the hopper 66 pays out a predetermined number of coins from a coin payout aperture 19 to the coin tray 18. The coin detector 67 is disposed in the coin payout aperture 19. The coin detector 67 outputs an input signal to the main CPU 41 when it detects the payout of a predetermined number of coins from the coin payout aperture 19.

Based on a control signal outputted from the main CPU 41, the graphic board 68 controls image displays in the upper image display panel 33, and the lower image display panel 16 as an output unit. The credit count stored in the RAM 43 is displayed on the credit count display unit 31 of the lower image display panel 16. The payout number of coins is displayed on a payout number display unit of the lower image display panel 16.

The graphic board 68 has a VDP (video display processor) that creates image data based on a control signal outputted from the main CPU 41, and a video RAM that temporarily stores the image data created by the VDP. The image data to be used when the VDP creates image data are contained in the game program read from the memory card 53, and then stored in the RAM 43.

The bill validating unit 22 determines whether the bill is valid or not, and accepts a legitimate bill into the cabinet 11. When the bill validating unit 22 accepts the legitimate bill, it outputs an input signal based on the amount of the bill to the main CPU 41. The main CPU 41 stores in the RAM 43 a credit count corresponding to the amount of the bill sent by the input signal.

Based on a control signal outputted from the main CPU 41, the ticket printer 35 prints on a ticket a bar code in which the data of the credit count, the time, and the identification number of the gaming machine 10 stored in the RAM 43 are coded, and then outputs the data as a bar coded ticket 39.

The card reader 36 reads data from the smart card and sends the data to the main CPU 41, and also writes data in the smart card based on a control signal from the main CPU 41. The key switch 38S is provided in the key pad 38. When a player operates the key pad 38, the key switch 38S outputs a predetermined input signal to the main CPU 41. Based on a control signal outputted from the main CPU 41, the data display unit 37 displays data read by the card reader 36, and the data that the player inputted through the keyboard 38.

A control panel 20, a reverter 21S, a coin counter 21C, and a cold-cathode tube 81 are connected to the door PCB 80. The control panel 20 is provided with a spin switch 23S corresponding to the spin button 23, a change switch 24S corresponding to the change button 24, a cash out switch 25S corresponding to the cash out button 25, a one bet switch 26S corresponding to the one bet button 26, and a maximum bet switch 27S corresponding to the maximum bet button 27. These switches 23S to 27S output input signals to the main CPU 41 when a player operates their respective corresponding buttons 23 to 27.

The coin counter 21C is provided in the coin slot 21, and determines whether the coin inserted in the coin slot 21 by the player is valid or not. Any coin other than a legitimate coin is discharged from the coin payout aperture 19. The coin counter 21C outputs an input signal to the main CPU 41 when it detects a legitimate coin.

Based on a control signal outputted from the main CPU 41, the reverter 21S operates to sort the coins recognized as the legitimate coin by the coin counter 21C into a cash box (not shown) or the hopper 66, disposed in the gaming machine 10. That is, the reverter 21S directs the legitimate coins into the cash box when the hopper 66 is filled with the coins. On the other hand, the reverter 21S directs the legitimate coins into the hopper 66 when the hopper 66 is not filled with the coins. The cold-cathode tube 81 functions as a backlight disposed on the back faces of the lower image display panel 16 and the upper image display panel 33. The cold-cathode tube 81 illuminates based on a control signal outputted from the main CPU 41.

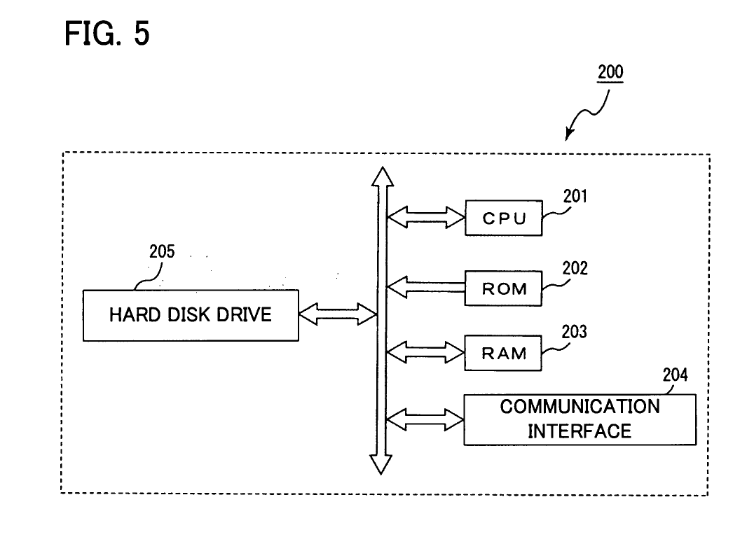

FIG. 5 is a block diagram showing the internal configuration of the management server according to the present embodiment.

The management server 200 has a CPU 201 as a processing unit, ROM 202, RAM 203, a communication interface 204, and a hard disk drive 205 as a storage unit. The communication interface 204 is connected via the communication line 101 to the communication interface 44 of each of the gaming machines 10. The ROM 202 stores a system program to control the operation of the controller, permanent data, and the like. The RAM 203 temporarily stores the data received from the gaming machines 10 and the data of operation results.

Based on the conversion result data received from the gaming machines 10 per a predetermined period (10 minutes in the present embodiment), the CPU 201 calculates the balance of the conversion results in the predetermined period. By adding, to the balance thus calculated, the balance in the whole period of time before the elapse of the predetermined period of time, the CPU 201 updates the balance in the whole period of time, and stores it as conversion history data. Then, a new conversion rate is calculated based on the conversion history data.

Specifically, the conversion rate can be calculated by the following method.

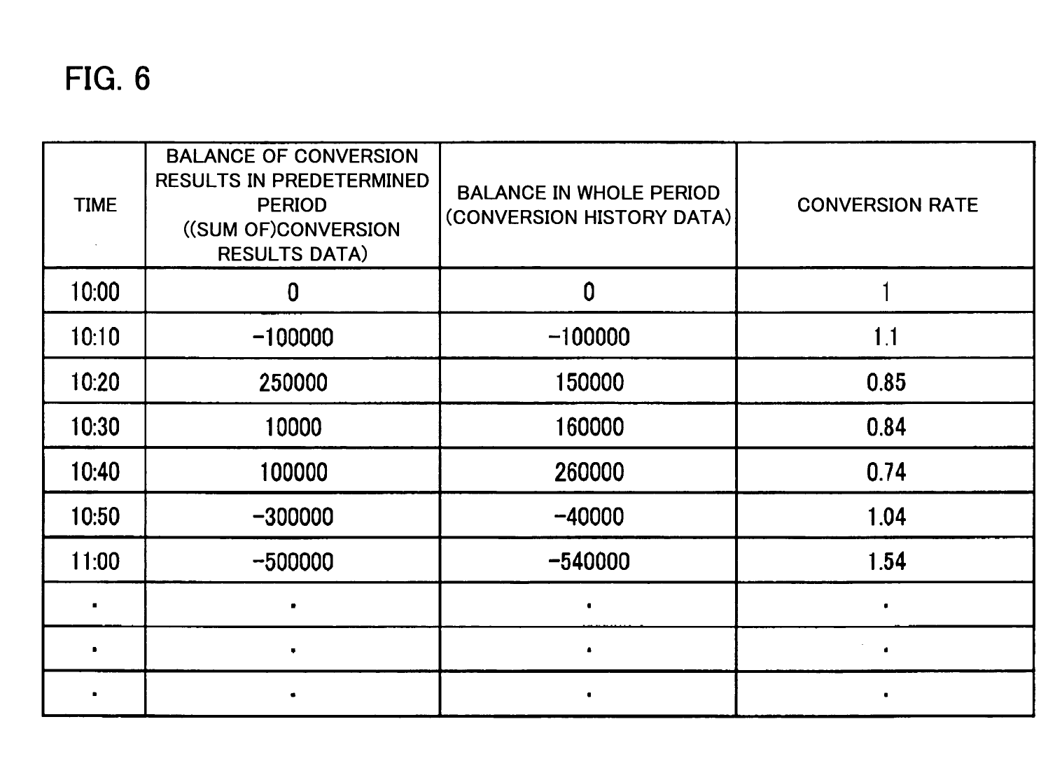

FIG. 6 is a diagram for explaining the conversion rate. For example, the column of “10:00” shows that the balance of the conversion result in the ten minutes from “9:50” to “10:00” is zero, which can be calculated based on the conversion result data received from the respective gaming machines 10 for the ten minutes. This also shows that the balance in the whole period of time until “10:00” is 0, and that the conversion rate at the point of “10:00” is 1. In the present embodiment, the description is provided for the case where the conversion rate at the point of “10:00” is set to 1 everyday. Alternatively, the conversion rate of the day before may be used continuously.

For example, the column of “10:10” shows that the balance of the conversion result in the ten minutes from “10:00” to “10:10” is −100000, which can be calculated based on the conversion result data received from the respective gaming machines 10 for the ten minutes. This also shows that the balance in the whole period of time until “10:10” is −100000, and that the conversion rate at the point of “10:10” is 1.1. In the present embodiment, the conversion rate can be calculated by “(Balance in the whole period of time before elapse of a predetermined period+Sum of conversion results in the period)/1000000.”

For example, the column of “10:20” shows that the balance of the conversion result in the ten minutes from “10:10” to “10:20” is +250000, which can be calculated based on the conversion result data received from the respective gaming machines 10 for the ten minutes. This also shows that the balance in the whole period of time until “10:20” is +150000, and that the conversion rate at the point of “10:20” is 0.85.

The conversion rate thus calculated is sent to the respective gaming machines 10 as conversion rate data. As a result, for example, from “10:10” the conversion between credit data and stock data is executed at a conversion rate of 1.1 in the respective gaming machines 10. Then, from “10:20” the conversion between credit data and stock data is executed at a conversion rate of 0.85 in the respective gaming machines 10.

The processes performed in the gaming machines 10 are described next. The main CPU 41 advances a game by reading and executing a game program.

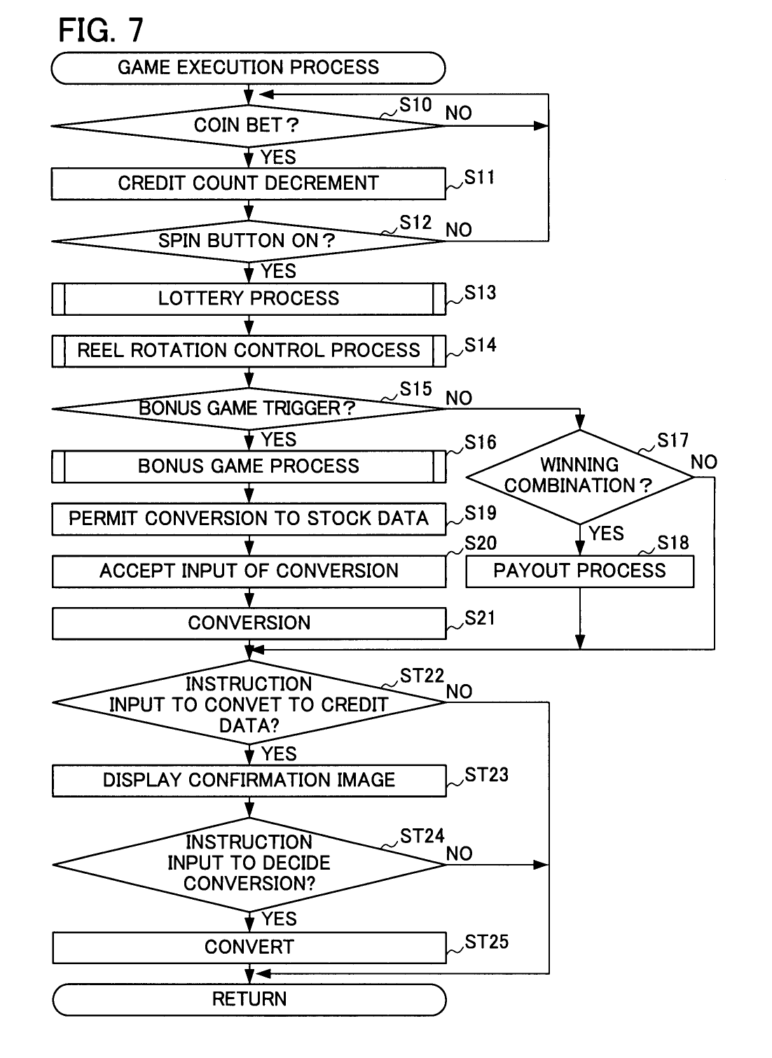

FIG. 7 is a flow chart showing a subroutine of a game execution process. In the game execution process, the main CPU 41 first determines whether a coin has been bet or not (step S10). In this process, the main CPU 41 determines whether it has received the input signal outputted from the one bet switch 26S when the one bet button 26 is operated, or whether it has received the input signal outputted from the maximum bet switch 27S when the maximum bet button 27 is operated. When the main CPU 41 determines that no coin has been bet, the procedure is returned to step S10.

When it is determined in step S10 that a coin has been bet, the main CPU 41 performs the process of decrementing the credit count stored in the RAM 43, depending on the number of coins bet (step S11). When the number of coins bet is larger than the credit count stored in the RAM 43, the process of decrementing the credit count stored in the RAM 43 is not performed, and the procedure is returned to step S10. If the number of coins bet exceeds the upper limit value that a player can bet per game (50 coins in the present embodiment), the process of decrementing the credit count stored in the RAM 43 is not performed, and the procedure is advanced to step S12.

Then, the main CPU 41 determines whether the spin button 23 has been pressed or not (step S12). In this process, the main CPU 41 determines whether it has received an input signal outputted from the spin switch 23 when the spin button 23 is depressed. If the main CPU 41 determines that the spin button 23 has not been depressed, the procedure is returned to step S10. If the spin button 23 has not been depressed (for example, if the spin button 23 has not been depressed and the instruction to terminate the game is inputted), the main CPU 41 cancels the result of the subtraction in step S11.

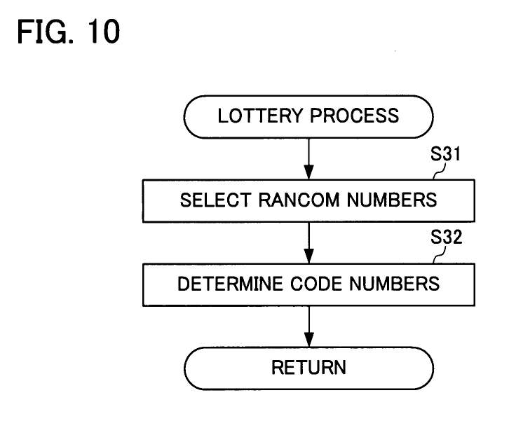

On the other hand, when it is determined in step S12 that the spin button 23 has been depressed, the main CPU 41 performs a lottery process (step S13). In the lottery process, the main CPU 41 executes the lottery program stored in the RAM 43 to determine the code numbers of the respective reels 14 when coming to a stop. This enables the decision of a combination of symbols to be stopped and displayed. This process is described in detail with reference to FIGS. 10 and 11. The present embodiment describes the case where a winning combination is selected from a plurality of types of winning combinations by determining a combination of symbols to be stopped and displayed. As an alternative of the present invention, a winning combination to be selected from the plurality of types of winning combinations may be first determined by lottery, and then a combination of symbols to be stopped and displayed may be determined based on the abovementioned winning combination.

The main CPU 41 then performs the rotation control process of the reels (step S14). In this process, after all of the reels 14 have started to rotate, the rotation of the reels are stopped to display the combination of symbols, corresponding to the winning combination determined in step S13, on the winning line L.

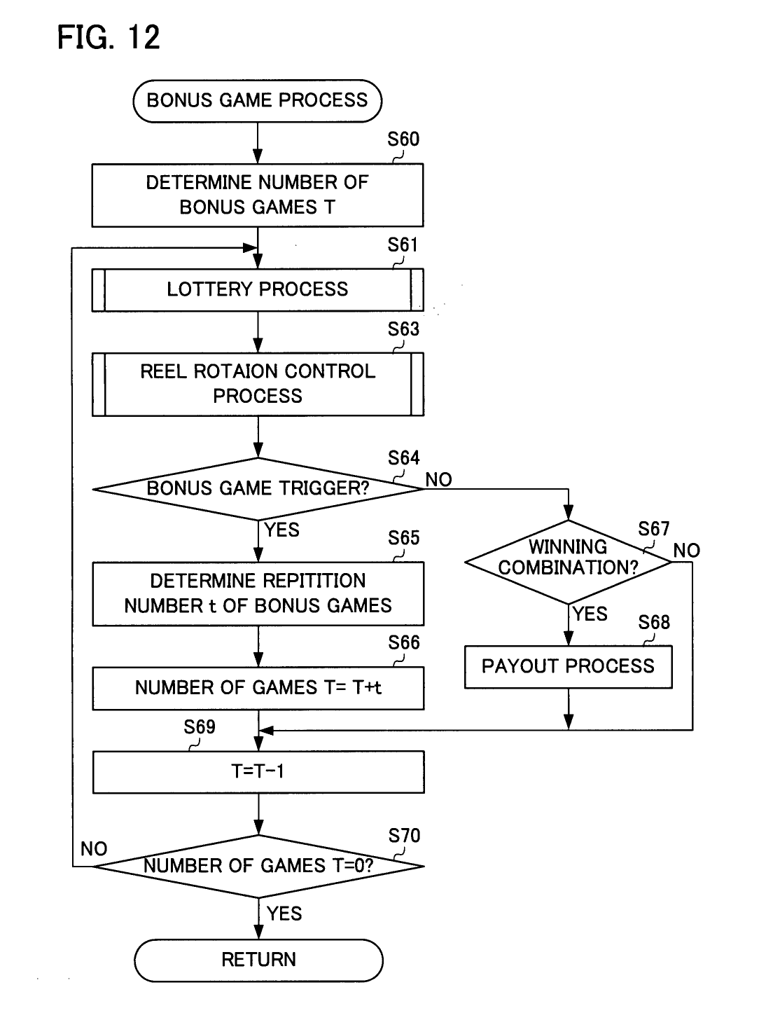

The main CPU 41 determines whether the bonus game has been triggered or not, namely whether an “APPLE” is stopped and displayed in the display window 15 (step S15). When it is determined that the bonus game has been triggered, the main CPU 41 reads the program for performing the bonus game from the RAM 43, and executes the bonus game process (step S16). The bonus game process is described in detail with reference to FIG. 12.

On the other hand, when the main CPU 41 determines that the bonus game has been triggered, the main CPU 41 determines whether a winning combination has occurred or not (step S17). When the CPU 41 determines that a winning combination has occurred, it pays out coins corresponding to the number of coins inserted and the winning combination (step S18).

For the storage of the coins, the main CPU 41 performs the process of incrementing the credit count stored in the RAM 43. On the other hand, for the payout of the coins, the CPU 41 sends a control signal to the hopper 66, and pays out a predetermined number of coins.

After executing the process of step S16, the main CPU 41 permits the conversion of credit data to stock data (step S19). In step S20, the main CPU 41 then accepts the input of the credit count to be converted to stock data. In the presence of the instruction input not to convert to stock data, the process in step S21 is not performed, and the procedure moves on to step S22. Thus, in the present embodiment, the conversion of credit data to stock data is allowed in the condition where a larger amount of credits exist after the bonus game process. Thus, the player can be further encouraged to convert credit data to stock data.

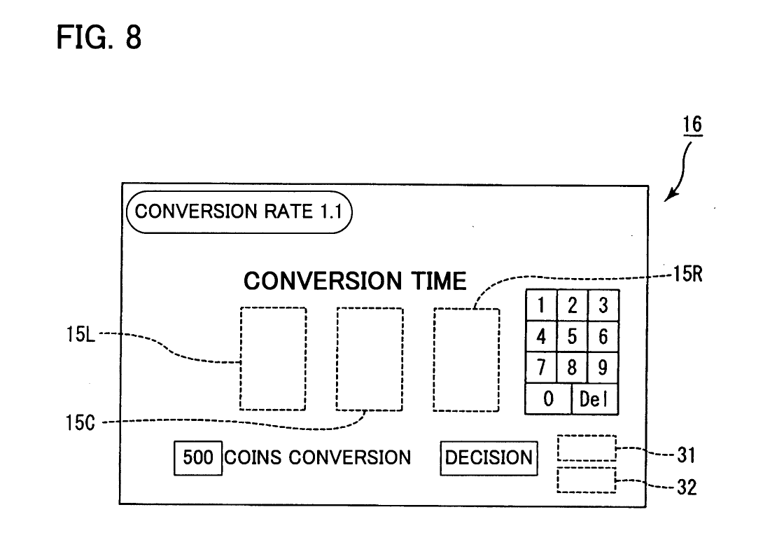

FIG. 8 is a diagram showing an example of images displayed on the lower image display panel when the conversion of credit data to stock data is allowed. An image indicating “conversion time,” an image indicating “conversion rate is 1.1,” an image indicating ten keys, an image indicating “decision,” and an image indicating a text box for inputting a credit count to be converted with stock data are displayed on the lower image display panel 16. These images can be displayed when the conversion of credit data to stock data is allowed in step S19. The image indicating the “conversion time” shows that credit data can be currently converted to stock data. The image indicating the “conversion rate 1.1” shows that the current conversion rate between credit data and stock data” is 1.1. In the present embodiment, the lower image display panel 16 also functions as a conversion rate display unit. In the present invention, the upper image display panel 33 may function as a conversion rate display unit, or the conversion rate display unit may be provided separately in the gaming machine 10. The player can input a numerical value to the text box by touching a predetermined position of the touch panel 69 corresponding to the display area of the image indicating the ten key. The player can also decide the numerical value inputted to the text box by touching a predetermined position of the touch panel 69 corresponding to the display area of the image indicating “decision”.

In step S21, the main CPU 41 refers to the conversion rate data stored in the RAM 43, and converts the inputted number of credits to stock data. For example, as shown in FIG. 6, if the time that the conversion input has been accepted is between 10:10 and 10:20, the conversion is made at a conversion rate of 1.1. If it is between 10:20 and 10:30, the conversion is made at a conversion rate of 0.85. Thereafter, the conversion is inhibited again. The conversion result is then sent as conversion result data to the management server 200 at a predetermined timing.

If the process of step S18 or S21 is executed, or if it is decided in step S17 that no winning combination has occurred (namely if decided as lose), the main CPU 41 determines whether there is an instruction input to convert stock data to credit data (step S22). If so, the main CPU 41 refers to the conversion rate data stored in the RAM 43, and performs the process of displaying on the lower image display panel 16 a credit count to be obtained by the conversion at that time (step S23). Then, the procedure moves on to step S24. On the other hand, in the absence of the instruction input, the present subroutine is terminated.

In step S24, the main CPU 41 determines whether there is an instruction input to decide the conversion. If so, the main CPU 41 converts stock data to credit data (step S25). In this process, based on the conversion rate, the main CPU 41 decrements the stock data stored in the RAM 43, and increments the credit data stored in the RAM 43. The conversion result is then sent as conversion result data to the management server 200 at a predetermined timing. On the other hand, in the absence of the instruction input to decide the conversion, namely in the presence of an instruction input to cancel the conversion, the present subroutine is terminated.

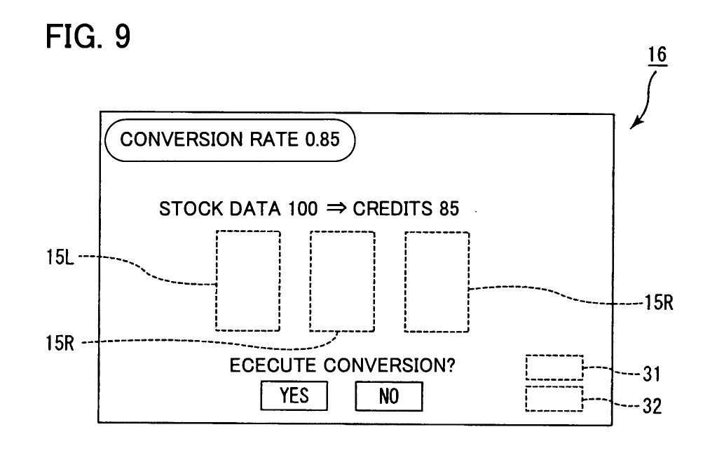

FIG. 9 is a diagram showing an example of images to be displayed on the lower image display panel in the presence of the input to convert stock data to credit data. The lower image display panel 16 displays an image indicating “Stock data 100 is converted to credits 85”, and an image indicating “Conversion rate is 0.85”, an image indicating “Execute conversion?”, and an image indicating “YES” and “NO”. These images can be displayed in the presence of the instruction input to convert stock data to credit data in step S22. The image indicating “Stock data 100 is converted to credits 85” shows that the player has “100” as the current stock data, and if this is converted to credit data, the result is 85. The image indicating “Conversion rate is 0.85” shows that the current conversion rate between credit data and stock data is 0.85. The image indicating “Execute conversion?” shows the state of waiting for the input to decide the conversion. The player can decide whether to convert by touching a predetermined position of the touch panel 69 corresponding to the display area of the image indicating “YES” or “NO”.

FIG. 10 is a flow chart showing a subroutine of a lottery process to be called and executed in step S13 in the subroutine shown in FIG. 7. This is the process to be executed by the main CPU 41 under the lottery program stored in the RAM 43. First, the main CPU 41 executes a random number generating program contained in the lottery program, thereby selecting random numbers corresponding to the three reels 14, respectively, from a numerical range of 0 to 255 (step S31). The present embodiment describes the case of generating random numbers under a program (the case of using so-called software-based random numbers). In the present invention, a random number generator may be provided to extract random numbers from the random number generator (to use so-called hardware random numbers).

Next, based on the selected three random numbers, the main CPU 41 (the processing unit) determines the code numbers of the respective reels 14 (refer to FIG. 3) (step S32). The code numbers of the reels 14 correspond to the code numbers of symbols stopped and displayed on the winning line L. The main CPU 41 determines a winning combination by deciding the code numbers of the respective reels 14. For example, if the code numbers of the reels 14 are decided as “00”, “00”, and “00”, this indicates that the winning combination is determined as “JACKPOT 7”.

Meanwhile, the winning combinations in the present embodiment are described herein. FIG. 11 is a table illustrating the relationship between a plurality of types of winning combinations and the possibility of achieving these winning combinations, and the payout number. The possibilities of achieving the winning combinations shown in FIG. 11 correspond to the case where the payout ratio in a game other than the bonus game is 88%. The possibilities of achievement shown in FIG. 11 are for showing the possibilities of achieving these winning combinations when the code numbers of the respective reels 14 are decided based on three random numbers by referring to data of symbol weighting. That is, the random numbers are not associated with the winning combinations, respectively.

The possibility of achieving the bonus game trigger is 0.5%. If a player wins the bonus game trigger, three symbols of “APPLE” are stopped and displayed on the winning line L, and the bonus game is executed. In the bonus game, a free game can be performed a number of times as decided by lottery.

The possibility of achieving “JACKPOT 7” is 0.5%. When this winning combination occurs, three symbols of “JACKPOT 7” are stopped and displayed on the winning line L, and 30 coins per coin bet are paid out. The table is set so that a lower possibility of achievement can receive a larger number payout. Any combination of symbols other than the combinations corresponding to the winning combinations shown in FIG. 11 is a loss, and no payout of coins is executed.

FIG. 12 is a flow chart showing a subroutine of the bonus game process to be called and executed in step S16 of the subroutine shown in FIG. 7. First, the main CPU 41 executes the random number generating program contained in the lottery program stored in the RAM 43, and based on the obtained random numbers, determines the number of games in the bonus game from a range of 10 to 25 games (step S60). The main CPU 41 stores as data the determined number of games in the bonus game in the RAM 43.

Then, the main CPU 41 performs a lottery process (step S61) and a reel rotation control process (step S63). The process in step S61 is substantially the same as the process described with reference to FIG. 10, and therefore the description thereof has been omitted here.

The main CPU 41 then determines whether the bonus game has been triggered or not, namely whether the symbol of “APPLE” has stopped and been displayed in the display window 15 (step S64). If so, the number of repetition t of the bonus game is newly decided by lottery (step S65). The decided number of repetition t is added to the number of games T in the present bonus game (step S66). Thus, when a player wins the bonus game during the time of the bonus game, the remaining number of the bonus games can be incremented. Specifically, for example, if the player at first switches to 20 bonus games, and the player wins 17 bonus games on the 12th bonus game, the player can thereafter play the bonus game 25 (20−12+17) times.

In cases where the bonus game has not been triggered, the main CPU 41 determines whether a winning combination has occurred or not (step S67). Consequently, the main CPU 41 pays out the number of coins in accordance with the number of coins inserted and the winning combination (step S68). This process is the same as the process in step S18, and therefore the description thereof has been omitted here.

In cases where the process in step S66 or S68 is executed, or when it is decided in step S67 that no winning combination has occurred (if decided as lose), the main CPU 41 reads the number of games T of the bonus game stored in the RAM 43, and decrements the value of the read number of games T by 1, and then stores the resulting number of games T in the RAM 43 (step S69).

Next, the main CPU 41 determines whether the number of times T of the bonus game has reached the number of times determined in step S60 (step S70). Specifically, the main CPU 41 determines whether the number of games T stored in the RAM 43 is zero or not. If the number of games T is not zero, namely if the number of executions of the bonus games does not reach the number of times determined in step S60, the procedure is returned to step S61, and the abovementioned processes are repeated. On the other hand, if the number of games T is zero, namely if it reaches the number of times determined in step S60, the present subroutine is terminated.

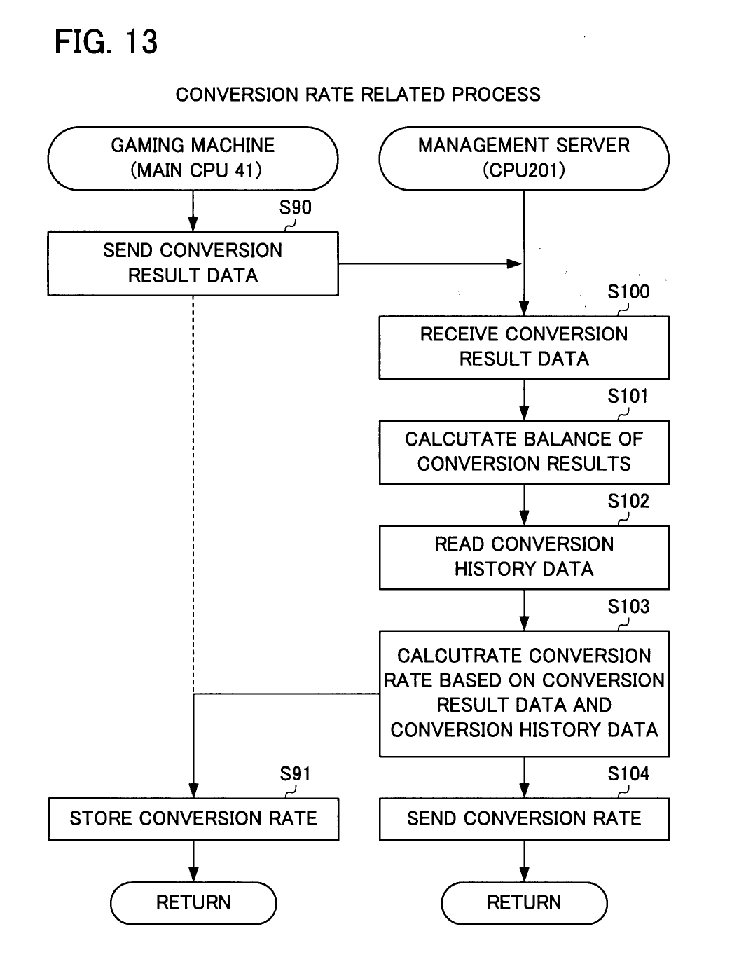

FIG. 13 is a flow chart showing a conversion rate related process executed between the gaming machines and the management server. First, the main CPU 41 of each of the gaming machines 10 sends conversion result data to the management server 200. The conversion result data can be sent when the conversion between credit data and stock data is made (refer to step S21 and step S25 in FIG. 7).

Upon the receipt of the conversion result data from the respective gaming machines 10, the CPU 201 of the management server 200 stores the data in the hard disk drive 205 (step S100). In step S101, every 10 minutes, the CPU 201 calculates the balance of the conversion results during the 10 minutes, based on the conversion result data stored in the hard disk drive 205.

In step S102, the CPU 201 reads the conversion history data stored in the hard disk drive 205. In step S103, the CPU 201 calculates a conversion rate by adding the abovementioned balance, in the 10 minutes calculated in step S101, to the balance in the whole period of time indicated by the conversion history data, followed by dividing the obtained value by a predetermined constant. The processes in steps S101 to step S103 correspond to the process of calculating a conversion rate based on the received conversion result data and the conversion history data stored in the abovementioned storage unit. In the present embodiment, the conversion rate is obtained by calculating every ten minutes the balance of the conversion results based on the received conversion result data (refer to step S100), and adding the value thus calculated to the balance in the whole period of time indicated by the conversion history data, followed by dividing the resulting value by a predetermined constant.

In step S104, the CPU 201 sends conversion rate data indicating the calculated conversion rate to the respective gaming machines 10.

Upon the receipt of the conversion rate data, the main CPU 41 of the gaming machines 10 updates the conversion rate data in the RAM 43. Thus, every time a conversion input occurs (refer to step S20 and step S24 in FIG. 7), the updated conversion rate is used to execute the conversion between credit data and stock data.

As described above, the gaming machines 10 according to the present embodiment are connected via the communication line 101 to the management server 200. The management server 200 determines a conversion rate based on the conversion history between credit data usable in the game and stock data (numerical data) convertible from credit data. The gaming machines 10 are provided with the RAM 43 as the storage unit, and the main CPU 41 as the processing unit. If conditions for conversion to stock data are met, the main CPU 41 converts the credit data stored in the RAM 43 to stock data, based on the conversion rate determined by the management server 200, and then stores the stock data in the RAM 43. If conditions for conversion to credit data are met, the main CPU 41 converts the stock data stored in the RAM 43 to credit data, based on the conversion rate determined by the management server 200, and then stores the credit data in the RAM 43.

The management server 200 according to the present embodiment is connected via the communication line 101 to a plurality of gaming machines 10. The management server 200 has the hard disk drive 205 (the storage unit), and the CPU 201 (the processing unit). The hard disk drive 205 stores credit data usable in the game and conversion history data indicating the conversion history between credit data and stock data convertible from credit data in the plurality of gaming machines 10. The CPU 201 executes the process of receiving the conversion result data indicating the conversion results between credit data and stock data in the plurality of gaming machines 10. The CPU 201 also executes the process of calculating a conversion rate based on the received conversion result data and the conversion history data stored in the hard disk drive 205. The CPU 201 also executes the process of sending conversion rate data indicating the calculated conversion rate to the plurality of gaming machines 10.

With the game control method according to the present embodiment, the following processes can be executed in the gaming system 100, where the management server 200 and a plurality of gaming machine 10 are connected via the communication line 101. The management server 200 receives the conversion result data indicating the conversion results between credit data and stock data from the gaming machines 10 connected via the communication line 101. The management server 200 calculates a conversion rate based on the received conversion result data and the conversion history data stored in the hard disk drive 205 (the storage unit) provided in the management server 200. The management server 200 sends conversion rate data indicating the calculated conversion rate to the plurality of gaming machines 10. Based on the received conversion rate data, the gaming machines 10 convert the credit data stored in the RAM 43 (the storage unit), provided in the gaming machines 10, to stock data, and then store the stock data in the RAM 43 provided in the gaming machines 10.

Therefore, with the gaming machine 10, the management server 200, and the game control method according to the present embodiment, stock data can be used to change the value thereof apart from credit data having values per unit that remain unchanged. Consequently, even with the gaming machine 10 using credit data having values per unit that remain unchanged, an element similar to the trading of stocks and bonds can be incorporated in the game so as to enhance the entertainment feature of the game in the gaming machine.

According to the gaming machines 10 and the game control method, the gaming machines 10 have the lower image display panel 16 (the display unit) that displays a plurality of symbols. The main CPU 41 provided in the gaming machines 10 performs the process of allowing conversion between credit data and stock data if the plurality of symbols are rearranged and “APPLE” has stopped and been displayed in the display window 15 (if the bonus game trigger is established).

Thus, the conversion of credit data to stock data is allowed in the condition where the bonus game trigger is established and the bonus game process is then executed: in other words, when a larger amount of credit exists. Hence, the player can be encouraged to convert credit data to stock data. Furthermore, since credit data can be converted to stock data when the bonus game trigger is established, the number of times to the perform conversion process can be restricted, thereby preventing overloading of the gaming machines 10 and the management server 200.

Alternatively, the gaming machine and the game control method may be configured as follows. That is, the gaming machines 10 may have the lower image display panel 16 (the display unit) that displays a plurality of symbols, and a stop switch that outputs a stop instruction signal to stop and display a plurality of symbols for variable display, depending on the manipulation by a player. For example, the stop switch may be a dedicated stop switch. Alternatively, a spin button, a change button, a cash out button, or a bet button may also function as the stop switch. Upon detecting the stop instruction signal from the stop switch, the main CPU 41 provided in the gaming machines 10 performs the process of stopping and displaying the plurality of symbols for variable display. When the plurality of symbols stopped and displayed corresponds to a predetermined combination, the CPU 41 in the gaming machines 10 performs the process of allowing conversion between credit data and stock data.

With this type of the gaming machines 10 and the game control method, the conversion is possible only when the stopped and displayed symbols correspond to a predetermined combination. This provides a game feature where the conversion is not always possible at the desired timing. In the period of time that a player desires the conversion in particular, there may be a high possibility that the player performs many games. This enables the player to enjoy both the game and the conversion game. Furthermore, performing the stop operation can give the player the feeling of satisfaction that the conversion could be made at the desired timing by the strategy of the player.

Moreover, in the gaming machines 10 and the game control method, the gaming machines 10 have the lower image display panel 16 (the conversion rate display unit) for displaying a conversion rate. Based on data related to a conversion rate received from the management server 200, the main CPU 41 (the processing unit), provided in the gaming machine 10, performs the process of displaying the conversion rate on the lower image display panel 16.

Hence, the player can view the conversion rate. This enables the player to consider the conversion timing while viewing the conversion rate, which varies from time to time, and decide whether to make the conversion in consideration of the progress up to then.

While the preferred embodiment of the present invention have been described and illustrated above, it is to be understood that they are exemplary of the invention and are not to be considered to be limiting. Additions, omissions, substitutions, and other modifications can be made thereto without departing from the spirit or scope of the present invention. Accordingly, the invention is not to be considered to be limited by the foregoing description and is only limited by the scope of the appended claims.

What is claimed is:

1. A gaming machine connected via a communication line to a management server that determines a conversion rate based on a conversion history between credit data and numerical data convertible with credit data, the gaming machine comprising:
a storage unit for storing credit data and numerical data; and
a processing unit for executing processes of:
(a) storing, in the storage unit, numerical data converted from the credit data based on a conversion rate determined by the management server; and
(b) storing, in the storage unit, credit data converted from the numerical data based on a conversion rate determined by the management server.

2. The gaming machine according to claim 1, wherein the processing unit executes the process of storing numerical data converted from the credit data, if conditions for conversion to numerical data are met.

3. The gaming machine according to claim 1, wherein the processing unit executes the process of storing credit data converted from the numerical data, if conditions for conversion to credit data are met.

4. The gaming machine according to claim 1, further comprising:
a display unit that displays a plurality of symbols, wherein
the processing unit executes a process of allowing conversion between credit data and numerical data when rearrangement of the plurality of symbols results in a predetermined combination.

5. The gaming machine according to claim 1, further comprising:
a display unit that displays a plurality of symbols; and
a stop switch that outputs a stop instruction signal via a manipulation by a player, wherein
the processing unit executes a process of stopping the plurality of symbols from varying when the stop instruction signal is detected, and a process of allowing conversion between credit data and numerical data when the stopped plurality of symbols corresponds to a predetermined combination.

6. The gaming machine according to claim 1, further comprising a conversion rate display unit, wherein
the processing unit executes a process of displaying the conversion rate on the conversion rate display unit.

7. A management server connected via a communication line to a plurality of gaming machines, comprising:
a storage unit that stores a conversion history between credit data and numerical data convertible with credit data; and
a processing unit for executing processes of:
(a) receiving conversion results between credit data and numerical data in the plurality of gaming machines;
(b) calculating a conversion rate based on data of the conversion results and data of the conversion history; and
(c) sending the conversion rate to the plurality of gaming machines.

8. A game control method of controlling a gaming system having a management server storing a conversion history, and a plurality of gaming machines being connected via a communication line to the management server and storing credit data and numerical data, the method comprising steps of:
having the management server calculate a conversion rate between credit data and numerical data;
having the management server send the conversion rate to the plurality of gaming machines;
having the gaming machine receive the conversion rate;
having the gaming machine convert credit data to numerical data based on the conversion rate;
having the gaming machine store conversion results between the credit data and numerical data; and
having the gaming machine send the conversion results to the management server.

9. The game control method according to claim 8, further comprising steps of:
having the management server receive the conversion results; and
having the management server calculate a conversion rate based on the conversion results and data of the conversion history.

10. The game control method according to claim 8, wherein the gaming machine includes a display unit for displaying a plurality of symbols, the method further comprising a step of:
allowing the gaming machine to convert between credit data and numerical data when rearrangement of the plurality of symbols results in a predetermined combination.

11. The game control method according to claim 8, wherein the gaming machine comprises a display unit that displays a plurality of symbols, and a stop switch that outputs a stop instruction signal by a manipulation via a player, the method further comprising a step of:
having the gaming machine stop the plurality of symbols from varying when the stop instruction signal is received; and
allowing the gaming machine to convert between credit data and numerical data when the stopped plurality of symbols corresponds to a predetermined combination.

12. The game control method according to claim 8, wherein the gaming machine has a conversion rate display unit, the method further comprising a step of:
having the gaming machines display the conversion rate on the conversion rate display unit.
